(19) United States
(12) Patent Application Publication
(10) Pub. No.: US 2008/0049461 A1
(43) Pub. Date: Feb. 28, 2008

(54) Power supply having multiple power output

(75) Inventors: Chin-Wen Chou, Taipei Hsien (TW); Ying-Nan Cheng, Taipei Hsien (TW)

Correspondence Address: BIRCH STEWART KOLASCH & BIRCH, PO BOX 747, FALLS CHURCH, VA, 22040-0747, US

(73) Assignee: &ZIPPY TECHNOLOGY CORP.

(21) Appl. No.: 11/508,268

(22) Filed: Aug. 23, 2006

(51) Int. Cl. H02M 5/45

(52) U.S. Cl. 363/37

(57) ABSTRACT

A power supply having multiple power output includes a power source to supply an AC signal to an EMI filter unit and a commutation unit that filter and commutate the AC signal and output a full wave/half wave pulse wave DC signal to an inverter which boosts voltage and outputs a high voltage electric signal to drive a first load. The invention further has a DC voltage transformation unit to receive the full wave/half wave pulse wave DC signal to lower the voltage and output a low voltage electric signal to a second load. Thus the power supply can supply multiple power and is more flexible and efficient. It can be adopted on display devices to provide low voltage DC power for other peripheral devices such as speakers, lamps, 3C products and the like.

### FIELD OF THE INVENTION

The present invention relates to a power supply and particularly to a power supply that has multiple power output.

### BACKGROUND OF THE INVENTION

In recent years electronic and computer products are quite popular. Applications of LCD are widely adopted. These days LCD technology has been expanded to home appliances. Demand of consumers also grows. Multiple functions and power saving have become focuses of research and development in the industry to appeal consumers and improve competitiveness in the market place.

R.O.C. patent publication No. 200534569 discloses two types of driving circuits. The first type of driving circuit provides an AC signal from a power source to a power supply, then the power supply transforms voltage to output an electric signal to an inverter to boost the voltage and output a high voltage electric signal. The present power supply to process the AC signal output from the power source includes an electromagnetic interference (EMI) filter unit, a commutation unit, a power factor corrector and a conversion unit. The EMI filter unit and commutation unit receive the AC signal to perform filtering and commutation processes and output a full wave/half wave DC signal, then the power factor corrector receives the full wave/half wave DC signal and performs power factor correction to output an electric signal to the conversion unit (DC-DC) which transforms voltage to output a low voltage signal to the inverter. The inverter boosts the voltage to become a high voltage electric signal to be sent to a load linking to a rear end.

Another type of driving circuit differs from the previous circuit as follow: the AC signal output from the power source is received by the EMI filter unit and commutation unit for filtering and commutation processes, and becomes a full wave/half wave DC signal to be output. The full wave/half wave DC signal is an intermediate voltage electric signal (such as the power source being 100V, the full wave/half wave DC signal being 150V). The intermediate voltage electric signal is sent to an inverter for voltage boosting to become a high voltage electric signal to be output to a load.

When the conventional driving circuits mentioned above are adopted on a flat panel display device, only the high voltage electric signal is provided to the load (namely a cold cathode fluorescent lamp—CCFL). As a result, no extra connection ports are added to the present display devices on the market.

Users have to couple required peripheral devices by themselves, such as speakers, small lamps, small 3C products sensible to screen images to generate interactions, and the like.

A power supply capable of providing multiple power output (including a lower voltage DC electric signal) adopted on the display device can make power supply more flexible and efficient. It also can expand the existing design architecture.

### SUMMARY OF THE INVENTION

The primary object of the present invention is to provide a power supply that has multiple power output. The power output includes at least a high voltage DC electric signal and a low voltage DC electric signal to drive different corresponding loads.

To achieve the foregoing object, the present invention includes an EMI filter unit and a commutation unit to receive an AC signal, and filter and rectify the signal and output a full wave/half wave pulse wave DC signal to an inverter to boost the voltage so that a high voltage electric signal is output to drive a first load. The invention also has a DC voltage transformation unit to receive the full wave/half wave pulse wave DC signal to lower the voltage and output a low voltage electric signal to a second load. Thereby multiple power can be output from the power supply. Applications of the power supply are more flexible and efficient. When adopted on a display device, an additional lower voltage DC connection port can be provided for users to couple desired devices.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of an embodiment of the invention.

FIG. 2 is another circuit block diagram of an embodiment of the invention.

FIG. 3 is a circuit block diagram of another embodiment of the invention.

### DETAILED DESCRIPTION OF THE PREFERRED EMBODIMENTS

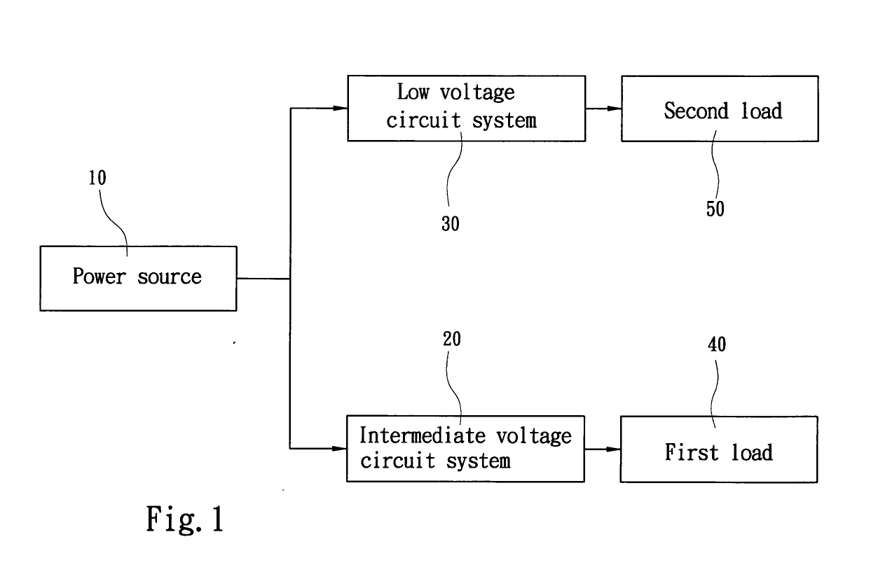

Please refer to FIG. 1 for the circuit block diagram of an embodiment of the invention. The power supply having multiple power output of the invention includes an intermediate voltage circuit system 20 to receive an AC signal from a power source 10 (may be city power) and a low voltage circuit system 30 coupled in parallel with the intermediate voltage circuit system 20 to drive respectively a first load 40 and a second load 50.

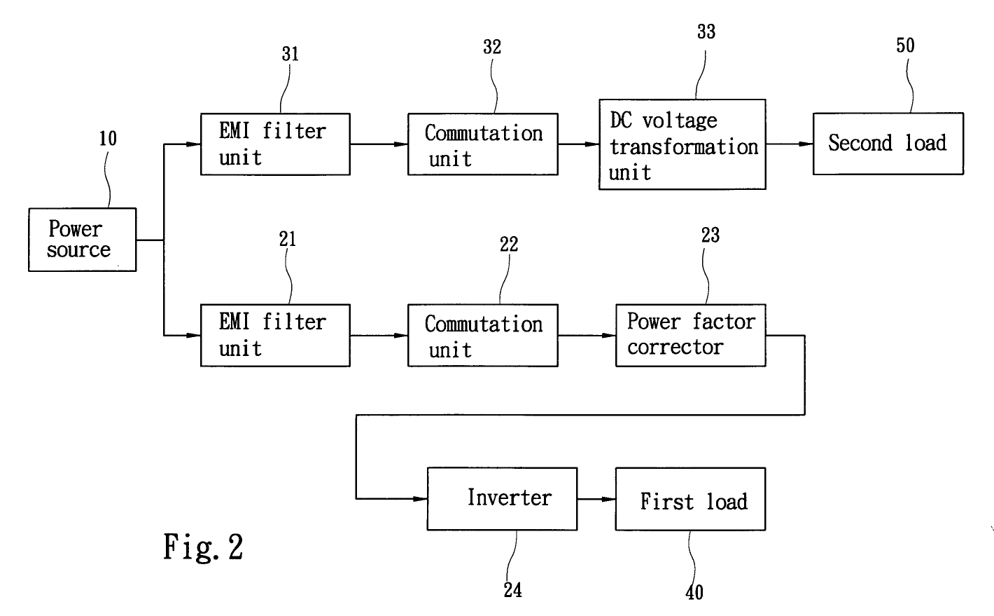

Referring to FIG. 2, the intermediate voltage circuit system 20 includes a first EMI filter unit 21, a first commutation unit 22, a power factor corrector 23 and an inverter 24 to output a high voltage electric signal to the first load 40 which may be a CCFL. The low voltage circuit system 30 includes a second EMI filter unit 31, a second commutation unit 32 and a DC voltage transformation unit 33 to output a low voltage electric signal to the second load 50 which may be a speaker, lamp or other 3C products.

More specifically, the driving circuit of the invention includes: a power source 10 to provide an AC signal. It may be city power to output electricity at a specification according to the specification of each country (such as 10V or 220V);

EMI filter units 21 and 31 and commutation units 22 and 32 that are bridge types consisting of diodes. The EMI filter unit 21 and commutation unit 22 are coupled in parallel with another EMI filter unit 31 and another commutation unit 32, and receive respectively the AC signal provided by the power source 10. The AC signal is filtered and rectified to become a full wave/half wave pulse wave DC signal to be output;

an inverter 24 which may be a piezoelectric inverter to receive the full wave/half wave DC signal and boost the voltage to output a high voltage electric signal to the first load 40. The commutation unit 22 and the inverter 24 may be bridged by a power factor corrector 23 according to environmental regulations of each country so that after the voltage of the full wave/half wave DC signal is transformed, it is sent to the inverter 24 to improve resonant wave distortion and phase deviation; and

a DC voltage transformation unit 33 which is a voltage-lowering transformer. It receives the full wave/half wave pulse wave DC signal and lowers the voltage to output a low voltage electric signal to the second load 50.

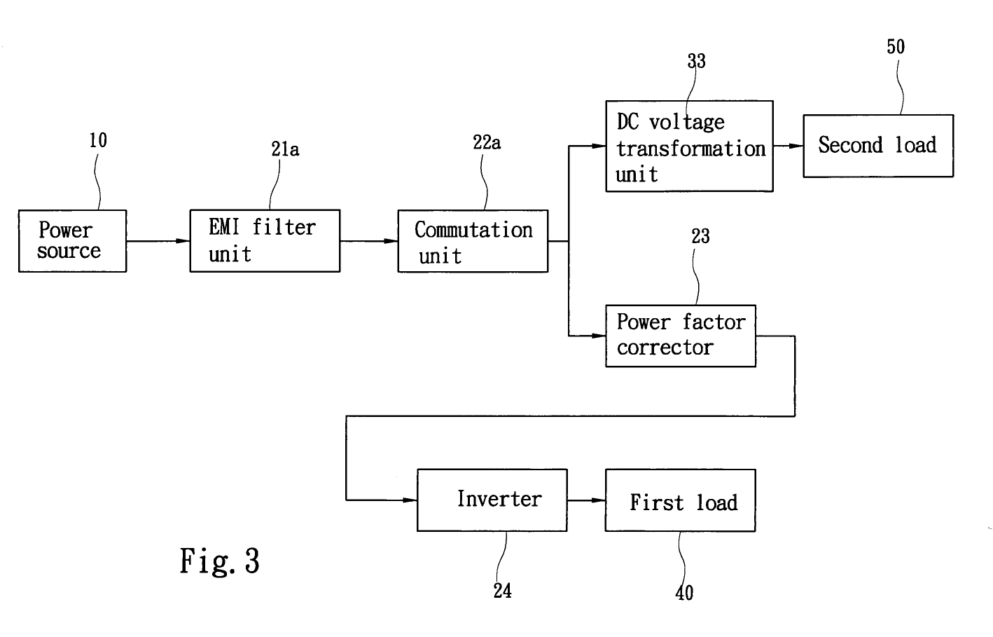

Refer to FIG. 3 for the circuit block diagram of another embodiment of the invention. The EMI filter units 21 and 31, and the commutation units 22 and 32 are integrated to become an EMI filter unit 21a and a commutation unit 22a. The commutation unit 22a is split to connect to the inverter 24 (or the power factor corrector 23 if there is one) and the DC voltage transformation unit 33 to simplify the structure of the driving circuit.

In short, in the present invention a power source 10 provides an AC signal to an intermediate voltage circuit system 20 and a low voltage circuit system 30 that are coupled in a parallel manner to drive respectively a first load 40 and a second load 50. Thereby one set of power supply can output multiple power. The power supply thus formed is more flexible and efficient. It can be used on a display device to provide a low voltage DC output connection port to couple with various products such as speakers, lamps, 3C products that require a low voltage DC power. Thus it can expand the existing design architecture in the industry.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply having multiple power output to receive an AC signal and supply at least two power output, comprising:
a first electromagnetic interference (EMI) filter unit and a first commutation unit to receive the AC signal and filter and rectify the AC signal to output a full wave/half wave pulse wave DC signal;
an inverter to receive the full wave/half wave pulse wave DC signal and boost voltage to output a high voltage electric signal; and
a DC voltage transformation unit to receive the full wave/half wave pulse wave DC signal, and lower the voltage to output a low voltage electric signal.

2. The power supply of claim 1, wherein the AC signal is provided by city power.

3. The power supply of claim 1, wherein the first commutation unit is a bridge type rectifier consisting of diodes.

4. The power supply of claim 1 further having a second EMI filter unit and a second commutation unit that are coupled with the first EMI filter unit and the first commutation unit in a parallel manner, the first and second commutation units outputting respectively the full wave/half wave pulse wave DC signal to the inverter and the DC voltage transformation unit.

5. The power supply of claim 1, wherein the first commutation unit is coupled with a power factor corrector which receives the full wave/half wave pulse wave DC signal to transform the voltage and output to the inverter.

6. The power supply of claim 5 further having a second EMI filter unit and a second commutation unit that are coupled with the first EMI filter unit and the first commutation unit in a parallel manner, the first and second commutation units outputting respectively the full wave/half wave pulse wave DC signal to the power factor corrector and the DC voltage transformation unit.

7. A display device having a secondary power output to receive an AC signal and drive a gas discharge lamp, comprising:
a display device which has a connection port to output electric power;
a first electromagnetic interference (EMI) filter unit and a first commutation unit to receive the AC signal and filter and rectify the AC signal to output a full wave/half wave pulse wave DC signal;
an inverter to receive the full wave/half wave pulse wave DC signal and boost voltage to output a high voltage electric signal to drive the gas discharge lamp; and
a DC voltage transformation unit to receive the full wave/half wave pulse wave DC signal, and lower the voltage to output a low voltage electric signal to the connection port.

8. The display device of claim 7, wherein the gas discharge lamp is a cold cathode fluorescent lamp (CCFL).

9. The display device of claim 7, wherein the first commutation unit is a bridge type rectifier consisting of diodes.

10. The display device of claim 7 further having a second EMI filter unit and a second commutation unit that are coupled with the first EMI filter unit and the first commutation unit in a parallel manner, the first and second commutation units outputting respectively the full wave/half wave pulse wave DC signal to the inverter and the DC voltage transformation unit.

11. The display device of claim 7, wherein the first commutation unit is coupled with a power factor corrector which receives the full wave/half wave pulse wave DC signal to transform the voltage and output to the inverter.

12. The display device of claim 11 further having a second EMI filter unit and a second commutation unit that are coupled with the first EMI filter unit and the first commutation unit in a parallel manner, the first and second commutation units outputting respectively the full wave/half wave pulse wave DC signal to the power factor corrector and the DC voltage transformation unit.
